(19) United States
(12) Patent Application Publication
(10) Pub. No.: US 2026/0200140 A1
(43) Pub. Date: Jul. 16, 2026

(54) SYNTHETIC FINGERPRINTS AND METHOD OF MANUFACTURING SYNTHETIC FINGERPRINTS FOR TESTING BIOMETRIC SENSORS

(71) Applicant: Visa International Service Association, San Francisco, CA (US)

(72) Inventors: Kelvin Chun, Foster City, CA (US); Sherri Tasto-Muller, San Ramon, CA (US); Jean Creignou, Friedrichsthal (DE); Steven Becker, Saarwellingen (DE); Julian Meyer, Merchweiler (DE); Khalid El Lahyany, Stiring-wendel (FR); Jens Feldmann, Eppelborn (DE); Thomas Velhagen, Schmelz (DE)

(73) Assignee: Visa International Service Association, San Francisco, CA (US)

(21) Appl. No.: 19/127,785

(22) PCT Filed: Sep. 29, 2023
(86) PCT No.: PCT/US2023/075472

§ 371 Date: May 7, 2025

Related U.S. Application Data
(60) Provisional application No. 63/384,314, filed on Nov. 18, 2022.

(51) Int. Cl. B29C 33/38; B29C 39/26; B29C 39/42; B29C 64/393; B33Y 50/02; B33Y 80/00; G06T 17/00

(52) U.S. Cl. CPC B29C 33/3842; B29C 39/26; B29C 39/42; B29C 64/393; B33Y 50/02; B33Y 80/00; G06T 17/00

(57) ABSTRACT

Apparatus, system, and method for generating a synthetic finger are disclosed. A three-dimensional (3D) model of a fingerprint is generated based on fingerprint data received from a database. A mold is creating based on the 3D model. A casting material is applied on the mold to create a synthetic finger. The synthetic finger includes a fingerprint formed on the casting material by the mold.

### CROSS-REFERENCE TO RELATED APPLICATION

This application claims the benefit of and priority under 35 U.S.C. § 119(e) to U.S. Provisional Application No. 63/384,314, filed Nov. 18, 2022, entitled SYNTHETIC FINGERPRINTS AND METHOD OF MANUFACTURING SYNTHETIC FINGERPRINTS FOR TESTING BIOMETRIC SENSORS, the contents of which is hereby incorporated by reference in its entirety herein.

### TECHNICAL FIELD

The present disclosure is directed to manufacturing synthetic fingerprints. More particularly, the present disclosure is directed to manufacturing synthetic fingers comprising synthetic fingerprints for testing fingerprint sensors used in fingerprint scanner systems to recognize a person.

### BACKGROUND

Current standards for false acceptance rate (FAR) and false rejection rate (FRR) evaluation for fingerprint sensors set by the International Organization for Standardization (ISO) and fast identity online (FIDO) rely on the evaluation using a large test crew of genuine persons to provide actual fingerprints. This evaluation technique has many drawbacks. The technique lacks comparability between test labs and as test crews change. Test positions/conditions for verifications are not defined. The technique provides almost no repeatability, for example, the test crew must be the same, which is difficult to achieve, and humans will not present their finger in same positions and pressure from test to test. Using actual fingerprints may raise privacy concerns in most countries. Current testing techniques have a high cost related to travel, motivation expenses, and legal management. It requires a long test time and the system is prone to human error (bad labeling of finger, false presentation of finger). Also, because the technique relies on live humans, it is nearly impossible to conduct the test during pandemic situations. Finally, getting ethnic and age diversity in human test subjects can be difficult depending on the test location.

### SUMMARY

In one aspect, the present disclosure provides a method of generating a synthetic finger. The method comprises receiving fingerprint data from a database; generating a three-dimensional (3D) model of a fingerprint based on the fingerprint data; creating a mold based on the 3D model; applying a casting material on the mold; and creating a synthetic finger comprising a fingerprint formed on the casting material by the mold.

In another aspect, the method comprises placing the mold in a vacuum chamber; applying a vacuum to the vacuum chamber; and releasing the vacuum before the casting material solidifies. In one aspect, the pressure level of the vacuum chamber is selected in a range of 0.2 bar to 0.8 bar. In one aspect, the method comprises removing the synthetic finger from the mold after releasing the vacuum.

In another aspect, the method comprises applying a foam material to the synthetic finger. In one aspect, the foam material has a predetermined thickness or rigidity, or combination thereof, to simulate different pressure levels applied to a fingerprint sensor. In one aspect, the method comprises applying a near field communication (NFC) circuit to the foam material. In one aspect, the NFC circuit is a radio frequency identification (RFID) tag.

In another aspect, creating the mold employs an additive process. In one aspect, the additive process is a high precision 3D printing process, where high precision is defined by printed features within a resolution of 1 to 5 micrometers.

In another aspect, the creating the mold employs a subtractive process. In one aspect the subtractive process is at least one of a high precision laser engraving or laser etching process, where high precision is defined by engraved features within a resolution of 1 to 5 micrometers.

In another aspect, the method comprises combining at least one of a jellifying product, a polymer product, or an additive, or any combination thereof in a predetermined ratio to reflect properties of human skin. In one aspect, the combination includes a mixture of gelatin, glycerin, water, salt, and acrylic paint with the following proportions relative to the total mass in grams: Glycerin [37-52%], Gelatin [8-16%], Salt [0-3%], Acrylic Paint [0-1%], completed with Distilled Water to 100% of the mass ([30-55%]). In one aspect, the Salt includes at least one of Sodium Chloride or Magnesium Chloride. In one aspect, the casting material can be liquid or a film. In one aspect, the jellifying material comprises at least one of gelatin, pectin casein, or agar, or any combination thereof. In one aspect, the polymer material comprises at least one of a natural glue or an artificial glue, or any combination thereof. In one aspect, the properties of human skin comprises at least one of optical, mechanical, conductivity, or thermal, or any combination thereof.

In another aspect, the method comprises applying a near field communication (NFC) circuit to a substrate. In another aspect, the method comprises applying a near field communication (NFC) circuit to the synthetic finger. In one aspect, the NFC circuit is a radio frequency identification (RFID) tag.

In another aspect, creating a 3D model of the fingerprint comprises creating a displacement map of ridges with a maximum vertical displacement selected in a range of 33 and 80 micrometers.

In another aspect, the method comprises modifying a fingerprint generated based on real fingerprint data to create the fingerprint used to create the mold.

In another aspect, the method comprises generating a near human fingerprint to create the fingerprint used to create the mold.

In another aspect, the database is a high resolution database, wherein high resolution is at least 500 pixels per inch.

In another aspect, the fingerprint is one of an artificial fingerprint, wherein an artificial fingerprint is one of a modified human fingerprint or a wholly created fingerprint independent of a human fingerprint.

In another aspect, the mold is a negative form of the fingerprint.

In one aspect, the present disclosure provides a synthetic finger assembly. The synthetic finger assembly comprises a substrate; a near field communication (NFC) circuit disposed on one side of the substrate; and a synthetic finger disposed on the NFC circuit. In one aspect, the NFC circuit comprises a radio frequency identification (RFID) tag.

In another aspect, the synthetic finger assembly comprises a foam material with a predetermined thickness disposed between the NFC circuit and the synthetic finger. In one aspect, an adhesive is disposed between the substrate and the NFC circuit, between the NFC circuit and the foam material, and between the foam material and the synthetic fingerprint. In one aspect, the synthetic finger is formed from a mixture of a jellifying product, a polymer product, or an additive, or any combination thereof in a predetermined ratio to reflect properties of human skin. In one aspect, the combination includes a mixture of gelatin, glycerin, water, salt and acrylic paint with the following proportions relative to the total mass in grams: Glycerin [37-52%], Gelatin [8-16%], Salt [0-3%], Acrylic Paint [0-1%], completed with Distilled Water to 100% of the mass ([30-55%]). In one aspect the Salt includes at least one of Sodium Chloride or Magnesium Chloride. In one aspect, the jellifying product is at least one of gelatin, pectin casein, or agar, or any combination thereof. In one aspect, the polymer product is at least one of natural glues or artificial glues, or any combination thereof. In one aspect, the properties of human skin is at least one of optical, mechanical, conductivity, or thermal, or any combination thereof. In one aspect, the foam material has a predetermined thickness or rigidity, or combination thereof, to simulate different pressure levels applied to a fingerprint sensor.

In another aspect, the synthetic finger comprises a three-dimensional fingerprint. In one aspect, the three-dimensional fingerprint is an artificial fingerprint, wherein the artificial fingerprint is one of a modified human fingerprint or a wholly created fingerprint independent of a human fingerprint.

In another aspect, an adhesive is disposed between the substrate and the NFC circuit and between the NFC circuit and the synthetic fingerprint.

In one aspect, the present disclosure provides a method of generating a synthetic finger. The method comprises receiving fingerprint data from a database; generating a plurality of three-dimensional (3D) models of a plurality of fingerprints based on the fingerprint data; creating a mold based on the 3D model for each of the plurality of fingerprints; creating an array of molds by combining each mold for each of the plurality of fingerprints; applying a casting material to the array of molds forming a sheet of casting material; and segmenting the sheet into individual synthetic fingers, wherein the synthetic fingers comprise a fingerprint formed on the casting material by the mold.

### BRIEF DESCRIPTION OF THE DRAWINGS

In the description, for purposes of explanation and not limitation, specific details are set forth, such as particular aspects, procedures, techniques, etc. to provide a thorough understanding of the present technology. However, it will be apparent to one skilled in the art that the present technology may be practiced in other aspects that depart from these specific details.

The accompanying drawings, where like reference numerals refer to identical or functionally similar elements throughout the separate views, together with the detailed description below, are incorporated in and form part of the specification, and serve to further illustrate aspects of concepts that include the claimed disclosure and explain various principles and advantages of those aspects.

The synthetic fingerprints and method of manufacturing synthetic fingerprints for testing biometric sensors disclosed herein have been represented where appropriate by conventional symbols in the drawings, showing only those specific details that are pertinent to understanding the various aspects of the present disclosure so as not to obscure the disclosure with details that will be readily apparent to those of ordinary skill in the art having the benefit of the description herein.

FIG. 1 illustrates a flow diagram of a process for manufacturing a synthetic finger comprising a synthetic fingerprint and testing a fingerprint/biometric sensor using the synthetic finger, according to at least one aspect of the present disclosure.

FIG. 2 illustrates a fingerprint generated using artificial intelligence techniques, according to at least one aspect of the present disclosure.

FIG. 3 illustrates a high resolution three-dimensional (3D) model used to create a mold for manufacturing a synthetic finger using the fingerprint shown in FIG. 2, according to at least one aspect of the present disclosure.

FIG. 4 illustrates a mold for manufacturing a synthetic finger using the 3D model shown in FIG. 3, according to at least one aspect of the present disclosure.

FIG. 5 illustrates a highfidelity synthetic finger manufactured using the mold shown in FIG. 4, according to at least one aspect of the present disclosure.

FIG. 6 illustrates a mold comprising a metal plate and an array of individual 3D fingerprint molds for manufacturing a plurality of synthetic fingers, according to at least one aspect of the present disclosure.

FIG. 7 illustrates a support structure comprising a frame to support the metal plate shown in FIG. 6 during the casting process and a casting material for casting the 3D fingerprint molds onto the casting material to create a plurality of synthetic fingers, according to at least one aspect of the present disclosure.

FIG. 8 illustrates a sheet 800 of casting material comprising an array of synthetic fingers created with the metal plate shown in FIGS. 6 and 7, where the synthetic fingers are being separated into strips from the array of synthetic fingers, according to at least one aspect of the present disclosure.

FIG. 9 illustrates the sheet 800 of casting material comprising an array of synthetic fingers shown in FIG. 8, where individual synthetic fingers are being separated from the strips, according to at least one aspect of the present disclosure.

FIGS. 10A-10E illustrate the steps for manufacturing a synthetic finger assembly for testing a fingerprint sensor used in fingerprint scanner systems to recognize a person, according to at least one aspect of the present disclosure, where:

FIG. 10A illustrates a substrate, or plate for mounting a synthetic finger, according to at least one aspect of the present disclosure;

FIG. 10B illustrates a first synthetic finger subassembly comprising an NFC (near field communication) circuit attached to the substrate, according to at least one aspect of the present disclosure;

FIG. 10C illustrates a second synthetic finger subassembly comprising a double-sided adhesive tape attached over the NFC circuit, according to at least one aspect of the present disclosure;

FIG. 10D illustrates a synthetic finger assembly, according to at least one aspect of the present disclosure; and

FIG. 10E illustrates an alternate synthetic finger assembly comprising a layer of foam interposed between a substrate and a synthetic finger, according to at least one aspect of the present disclosure.

FIG. 11 illustrates a dispensing tray comprising a plurality of synthetic finger assemblies manufactured using the process shown in FIG. 10A-10D or 10E, according to at least one aspect of the present disclosure.

FIG. 12 illustrates a dispensing tray comprising a plurality of synthetic finger assemblies manufactured using the process shown in FIG. 10A-10D or 10E, according to at least one aspect of the present disclosure.

FIG. 13 illustrates a method of generating a synthetic finger as described in connection with FIGS. 1-12, according to at least one aspect of the present disclosure.

FIG. 14 is a block diagram of a computer apparatus with data processing subsystems or components, according to at least one aspect of the present disclosure.

### DESCRIPTION

This application is related to U.S. Provisional Patent Application Ser. No. 63/384,326, filed Nov. 18, 2022, titled ROBOTIC AUTOMATION TESTING APPARATUS AND METHOD FOR TESTING BIOMETRIC SENSORS WITH SYNTHETIC FINGERPRINTS, which is herein incorporated by reference in its entirety.

The following disclosure may provide exemplary systems, devices, and methods for conducting a financial transaction and related activities. Although reference may be made to such financial transactions in the examples provided below, aspects are not so limited. That is, the systems, methods, and apparatuses may be utilized for any suitable purpose.

In one aspect, the synthetic fingerprints and the process for manufacturing the synthetic fingerprints for testing biometric sensors disclosed herein were not foreseen as being acceptable by most biometric sensor manufacturers due to anti-spoofing considerations. The synthetic fingerprints and the process for manufacturing the synthetic fingerprints disclosed herein, however, provide an improvement over existing biometric sensor testing systems due to significant improvements in the generation of synthetic fingerprints using artificial intelligence (AI) and the creation of realistic synthetic fingerprints not recognized as such by the fingerprint/biometric sensors under test. The synthetic fingerprints disclosed herein are generated using high quality synthetic fingerprint images, high quality molds, and casting materials. The synthetic finger assemblies can be read by a variety of different fingerprint/biometric sensors under test. Accordingly, the synthetic fingerprints and the process for manufacturing the synthetic fingerprints for testing biometric sensors disclosed herein provide a significant improvement over conventional fingerprint/biometric sensor systems.

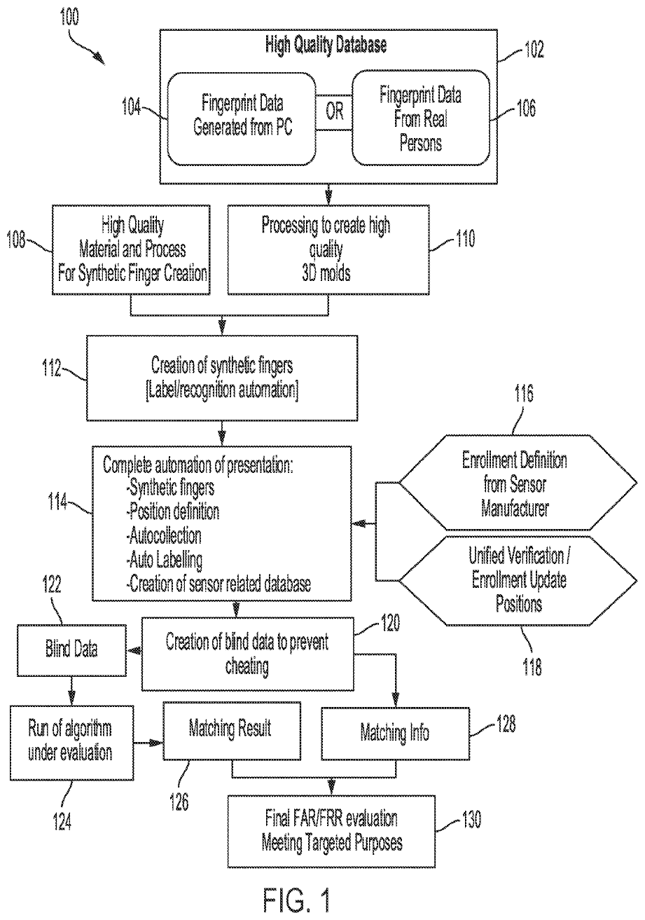

Turning now to the figures, FIG. 1 illustrates a flow diagram of a process 100 for manufacturing a synthetic finger comprising a synthetic fingerprint and testing fingerprint/biometric sensors using the synthetic finger, according to at least one aspect of the present disclosure. The process 100 starts with the creation of a high quality database 102 with a fingerprint image resolution between 500 ppi (pixels per inch) to 1000 ppi or greater, for example. The database 102 can have different origins, for example, two main database 102 sources as follows.

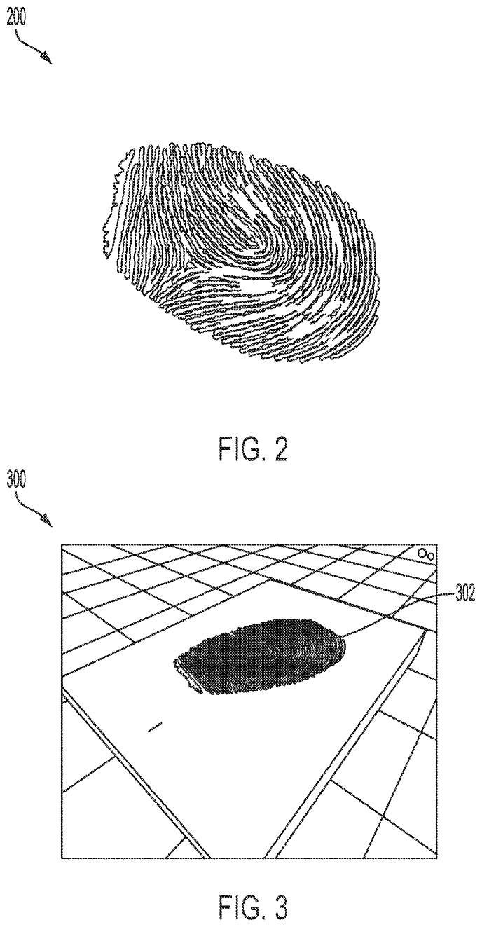

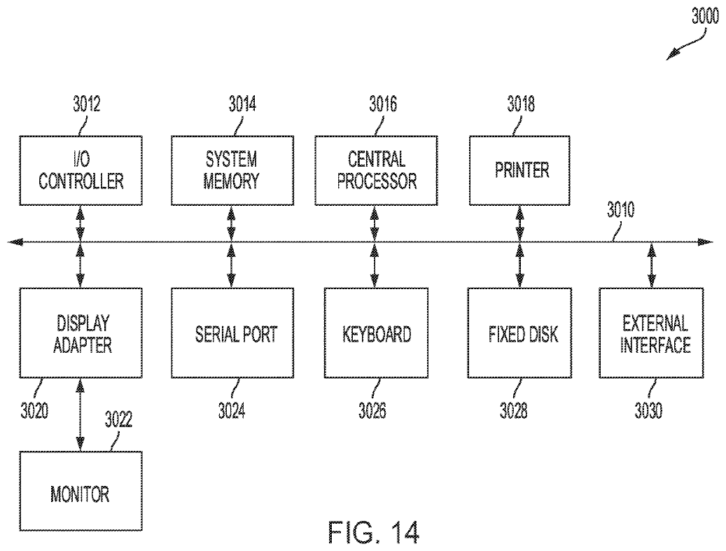

In one aspect, a first fingerprint database 104 comprises fingerprint data generated by a computer (e.g., the computer apparatus 3000 shown in FIG. 14) using AI generated fingerprint techniques or other training algorithms to generate reliable and near human fingerprints. AI techniques can include, for example, using Generative Adversarial Neural Networks (GAN or styleGAN) and/or other software techniques to improve the last layer resolution of fingerprint data. The GANs are effective at generating large high-quality images and to train more generator models. The Style-GAN, is an extension to the GAN architecture, including the use of a mapping network to map points in latent space to an intermediate latent space, the use of the intermediate latent space to control style at each point in the generator model, and the introduction to noise as a source of variation at each point in the generator model. The resulting model is capable not only of generating photorealistic high-quality photos of human features such as fingerprints, but also offers control over the style of the generated image at different levels of detail through varying the style vectors and noise. In one aspect, AI can be used on a final layer to improve generation from growing patterns using minutia or patterns generated using fixed algorithms such as, for example, multiresolution analysis algorithms (e.g., Min-Temp MultiRes or low level AI generation Syn-Re-GAN). Such techniques, however, may provide results of lower similarity to a human finger. FIG. 2 illustrates an example of a fingerprint 200 generated using AI techniques, according to at least one aspect of the present disclosure.

With reference back to FIG. 1, in another aspect, a second fingerprint database 106 comprises fingerprint data from real persons that can be employed by the process 100. The use of the second fingerprint database 106 collected from real human fingerprints guarantees similarity to real human fingerprints. However, this technique can considerably lower certain benefits and diversity that can be realized using the AI generated fingerprint database 104.

One example of AI Software used for generating a fingerprint database includes a pre-trained model configuration file (CFG) and a synthetically generated dataset publicly available as Clarkson Fingerprint Generator, which is an example of a Style-GAN described above. Example databases of real person fingerprints includes some involving the CrossMatch Gardian sensor or the Biometrica Hi Scan Sensor as for example the NIST Special Database 301. These databases of real person fingerprints can be used by the process 100 to modify the real persons fingerprint data to generate synthetic fingerprints, for example.

Once the high quality database 102 has been created, the process 100 includes the creation of a synthetic finger 112 using high quality/fidelity quality material 108. The creation of the synthetic finger 112 can employ a material having optical, mechanical, electrical conductivity, and thermal conductivity, among other properties, reflecting the properties of real human skin. The high-fidelity quality materials exhibiting real human skin properties include jellifying products (e.g., gelatin, pectin casein, agar), polymer products (natural or artificial glues), and/or additives mixed in ratios to produce a casting material that reflects properties of real human skin.

The creation of a synthetic finger 112 includes the creation of high quality 3D molds 110. A high quality 3D model of a fingerprint is created using fingerprint data read from the high quality database 102. The high quality 3D model uses greyscale as a displacement map on a high-resolution grid. The displacement map is used to achieve a maximum vertical displacement between 30 and 80 μm in order to reflect the real repartition of friction ridge depth of a real fingerprint. The high quality 3D model is then used to create molds using a 3D process. A high quality fingerprint image has a resolution between 500 ppi (pixels per inch) to 1000 ppi or greater, as discussed above. FIG. 3 illustrates a high resolution 3D model 300 of a fingerprint 302 used to create high quality 3D molds for manufacturing a synthetic finger using the high resolution fingerprint shown in FIG. 2, according to at least one aspect of the present disclosure.

In one aspect, the present disclosure provides a process for transforming the fingerprint image in a 3D model using commercially available image processing techniques and image manipulation software. In practice, software such as “Python” with the libraries “numpy” and “PIL” enabled fast and easy image processing.

In one aspect, an image processing technique includes inverting the fingerprint image (if needed) such that the background correspond to “0” black and the fingerprint appears in white. If any non-zero value is present at the border of the image, a soft frame having a width of 5 pixels is created around the image with 0 value (increase size). The greyscale repartition is modified linearly such that the image greyscale is in a range from 0 to 255. If several images from the same finger are available, the image with the best coverage and/or less rotation is selected. The fingerprint is centered. The image size is modified using LANCZOS interpolation in order to target an image with 3000 ppi and an upscale to compensate for any shrinkage. For example, using a final material with shrinkage of 9.09% (dividing by 1.1), a 500 ppi image is up-scaled with a factor 6.6. The image is cropped to correspond to the size of the target pattern. For example, a crop to (3064,3776) for an area of 26 mm×32 mm. If any non-zero value is present at the border of the cropped image a soft frame of 6 to 12 pixel width is overlapped around the image with 0 value (keep size).

The following 3D meshing technique can be performed with commercially available 3D software. The software Blender® has been successfully used in this context. The 3D meshing technique starts by creating a mesh representing a square of the large area (example 26 mm×32 mm). The mesh is subdivided such that the plane is composed of a grid of vertex every 25 μm (in Blender we used 1 unit=1 mm). A displacement modifier is used (Displace in Blender®) using the input image as texture (unwrap the texture such that the size corresponds) and the strength is set such that a complete white pixel corresponds to the desired maximal displacement (so between 33 and 81 μm—this also considers the shrinkage of the material used for creating the final synthetic finger). The displacement is applied and a final mesh is obtained to allow 3D engraving, such as laser engraving/etching.

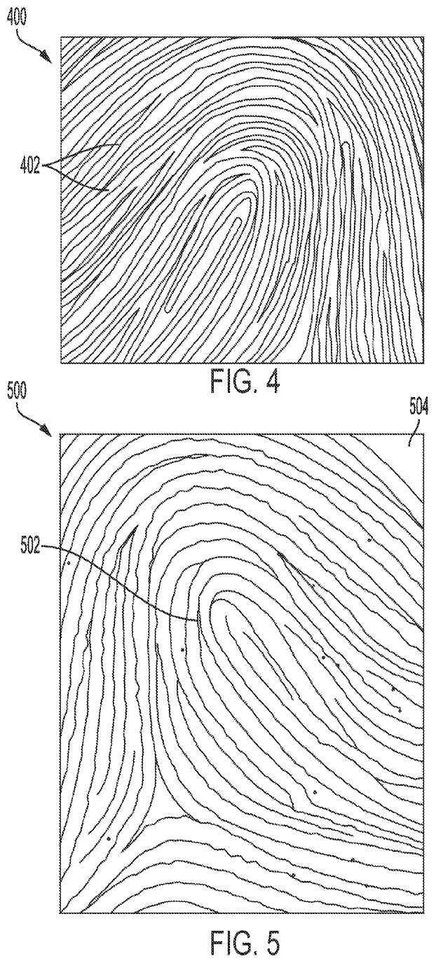

With reference back to FIG. 1, the creation of the 3D mold 110 can employ additive or subtractive processes, or combinations thereof. In one aspect, the process of creating a 3D mold 110 can include a high precision additive model (1-5 μm) such as 3D printing, for example. In another aspect, the process of creating 100 a 3D mold can include a subtractive process such as high precision laser engraving/etching on a metal plate, for example. Creation of the 3D mold 110 includes automatic labeling on the image (white text in the image) to allow easy identification of the later produced synthetic fingerprints. FIG. 4 illustrates a mold 400, or pattern, for manufacturing a synthetic finger using the 3D model 300 shown in FIG. 3, according to at least one aspect of the present disclosure. The mold 400 including high resolution fingerprint features 402 is formed using the displacement map having a maximum vertical displacement between 33 and 80 μm, as discussed above. The mold 400 is a negative image of the synthetic fingerprint.

FIG. 5 illustrates a high-fidelity synthetic finger 500 manufactured using the mold 400 shown in FIG. 4, according to at least one aspect of the present disclosure. With reference to FIG. 1 together with FIGS. 4 and 5, the high-fidelity synthetic finger 500 comprises a synthetic fingerprint 502 formed on a casting material 504. The synthetic fingerprint 502 is a positive image of a fingerprint. The synthetic finger 500 is created by applying the synthetic finger casting material 504 onto the 3D molds 400. The casting is done by placing the 3D mold 400 with the casting material 504 in a vacuum chamber an applying a vacuum pressure of 0.8 bar (absolute: 0.2 bar), then releasing the vacuum before the casting material 504 solidifies. The casting material 504 is then used to create the high-fidelity synthetic finger 500. In various aspects, the high-fidelity synthetic finger 500 can be mounted on a plate or substrate, with different foams to reflect different fingerprint pressure levels. Fast and easy contactless authentication of the synthetic finger 500 is done using a near field communication (NFC) circuit, which can be a radio frequency identification (RFID) tag, as described in more detail herein below.

The casting material 504 may be made according to various recipes. For example, the synthetic finger 500 can be created using a casting material having optical, mechanical, electrical conductivity, and/or thermal conductivity, among other properties reflecting real human skin. Such casting materials can include, for example, jellifying materials (e.g., gelatin, pectin casein, agar), polymer materials (e.g., natural or artificial glues), and additive materials to reflect properties of real human skin. In particular, in one aspect, a recipe for the casting material 504 can include a mixture of gelatin, glycerin, water, salt, and acrylic paint with the following proportions (relative to the total mass in grams): Glycerin [37-52%], Gelatin [8-16%], Salt (e.g., Sodium Chloride and/or Magnesium Chloride) [0-3%], Acrylic Paint [0-1%], completed with Distilled Water to 100% of the mass ([30-55%]).

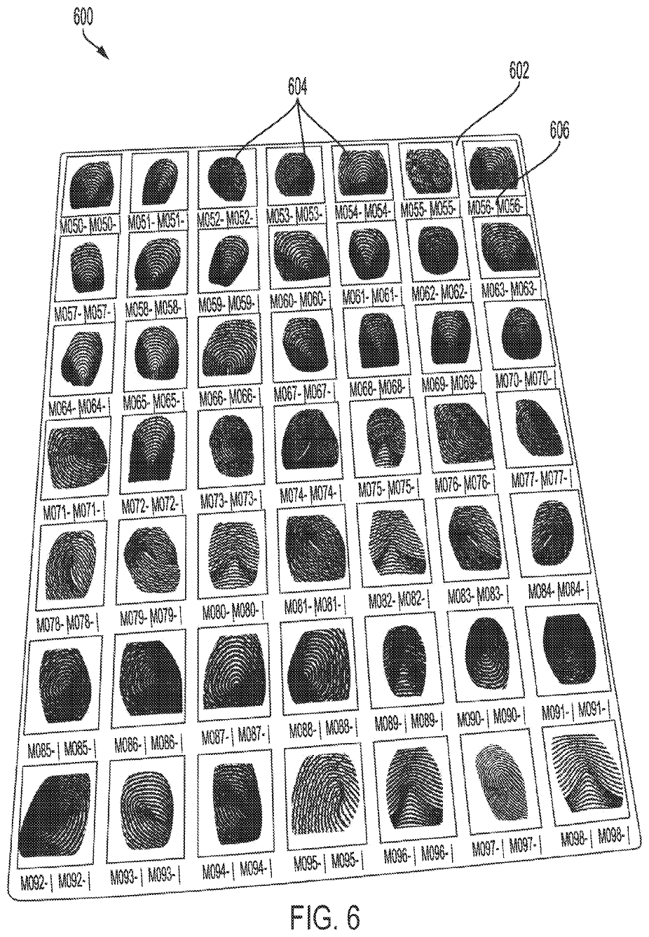

FIG. 6 illustrates a mold 600 comprising a metal plate 602 and an array of individual synthetic 3D fingerprint molds 604 for manufacturing a plurality of synthetic fingers, according to at least one aspect of the present disclosure. The array of 3D fingerprint molds 604 is formed on a metal plate 602. As discussed above, the fingerprint molds 604 can be made using a high precision additive process such as 3D printing, for example, or a high precision subtractive process such as a high precision laser engraving, for example. The 3D fingerprint molds 604 each can include a label 606 formed near the image of the fingerprint to allow identification of the synthetic fingerprints. The metal plate 602 shown in FIG. 6, yields 49 fingerprints. Those skilled in the will appreciate, however, that a metal plate may include any number of fingerprint molds, without limitation.

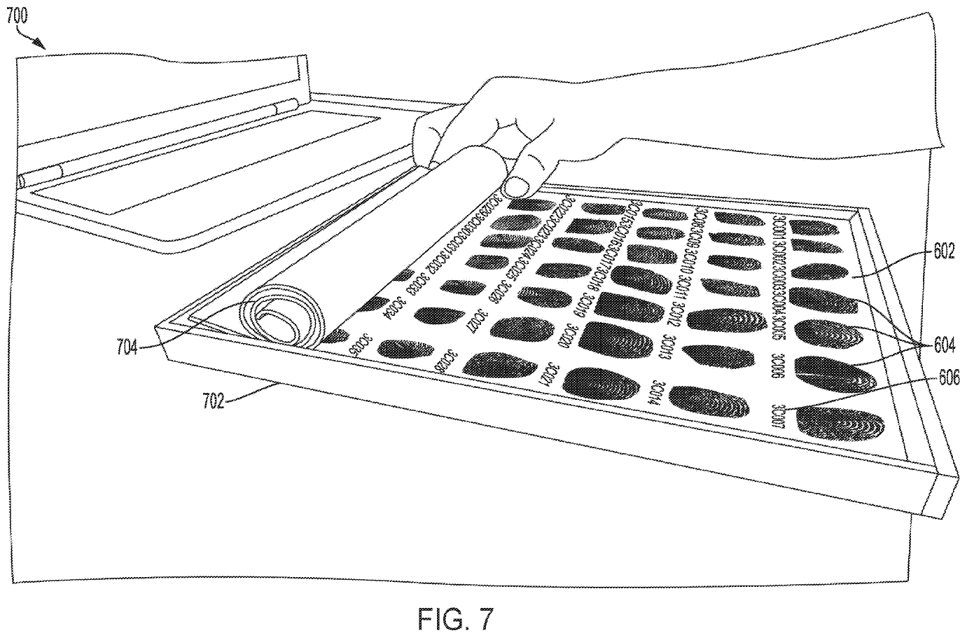

FIG. 7 illustrates a support structure 700 comprising a frame 702 to support the metal plate 602 shown in FIG. 6 during the casting process and a casted material 704. The 3D fingerprint molds 604 on the metal plate 602 are casted onto the casted material 704 to create a sheet of casted material 704 comprising a plurality of synthetic fingerprints, according to at least one aspect of the present disclosure.

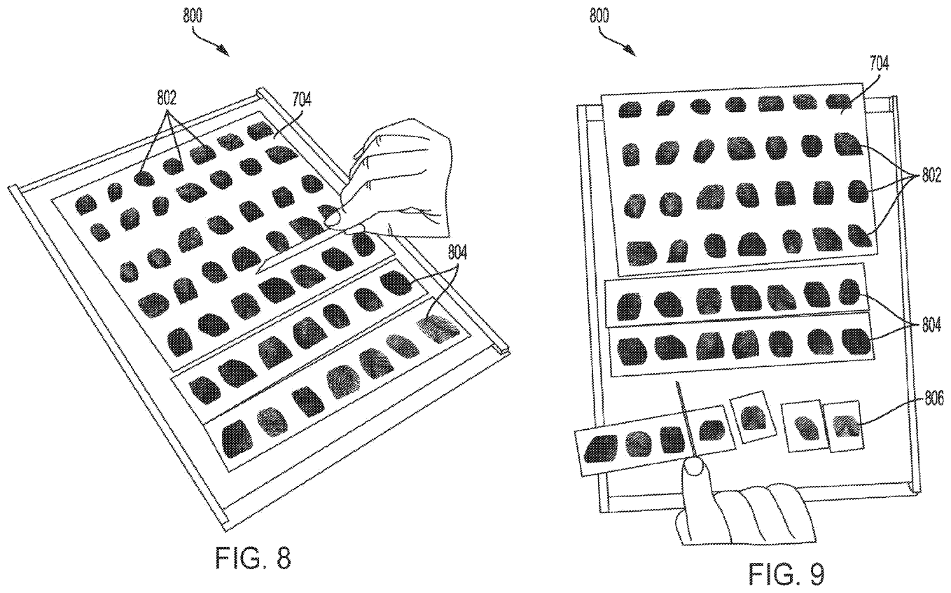

FIG. 8 illustrates a sheet of casted material 704 comprising an array of synthetic fingers 802 created using the metal plate 600 and casting material 704 shown in FIGS. 6 and 7. As shown in FIG. 8, the synthetic fingers 802 are being separated into strips 804 from the array of synthetic fingers 802, according to at least one aspect of the present disclosure. In one aspect, the synthetic fingers 802 are separated by a robotic arm.

FIG. 9 illustrates the sheet of casted material 704 comprising an array of synthetic fingers 802 shown in FIG. 8. The individual synthetic fingers 806 are being separated from the strips 804, according to at least one aspect of the present disclosure. In one aspect, the synthetic fingers 802 are separated by a robotic arm.

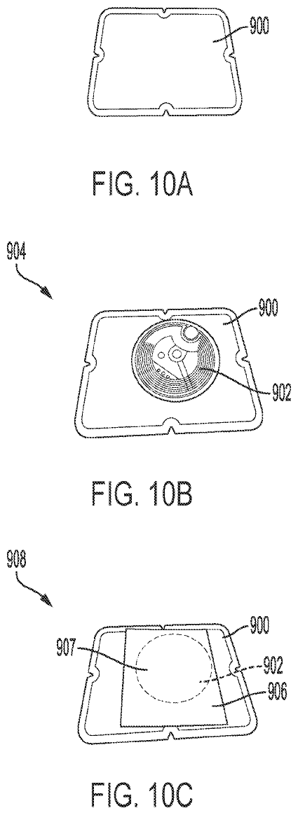

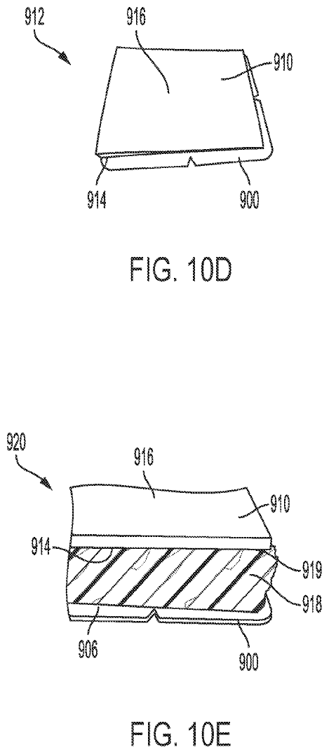

FIGS. 10A-10D illustrate the steps for manufacturing a synthetic finger assembly for testing a fingerprint sensor used in fingerprint scanner systems to recognize a person, according to at least one aspect of the present disclosure. FIG. 10E illustrates an alternate synthetic fingerprint assembly 920.

FIG. 10A illustrates a substrate 900, or plate, for mounting a synthetic finger thereon. The substrate 900 can be made of any rigid or semi-rigid material suitable for supporting the components of a synthetic finger assembly 912, 920 shown in FIGS. 10D, 10E, respectively, for example. In one aspect, the substrate 900 can be formed of a polymeric material such as plastic, for example. In one aspect, the polymer or plastic can be a bio-based polymer such as Polylactic Acid (PLA), for example.

FIG. 10B illustrates a first synthetic finger subassembly 904 comprising an NFC circuit 902 attached to the substrate 900. In one aspect, the NFC circuit 902 can be an RFID tag. In one aspect, the NFC circuit 902 can be attached to the substrate 900 with an adhesive, such as, for example, an adhesive sticker provided on one side of the NFC circuit 902.

FIG. 10C illustrates a second synthetic finger subassembly 908 comprising a piece of double-sided adhesive tape 906 attached over the NFC circuit 902. A top side 907 of the double-sided adhesive tape 906 is shown ready to receive a synthetic finger 910 as shown in FIG. 10D.

FIG. 10D illustrates a synthetic finger assembly 912, according to at least one aspect of the present disclosure. A bottom side 914 of a synthetic finger 910, manufactured in accordance with steps 102-112 of the process 100 shown in FIG. 1, is attached to the top side 907 (FIG. 10C) of the double-sided adhesive tape 906. A fingerprint portion of the synthetic finger 910 is on a top side 916 of the synthetic finger 910. The synthetic finger assembly 912 is shown ready to be used in a fingerprint/biometric sensor testing process.

FIG. 10E illustrates an alternate synthetic fingerprint assembly 920 comprising a layer of foam material 918 interposed between the substrate 900 and the synthetic finger 910, according to at least one aspect of the present disclosure. In the aspect illustrated in FIG. 10E, a bottom side of the foam material 918 is attached to the top side 907 (FIG. 10C) of the double-sided adhesive tape 906. A second adhesive layer 919 is attached to a top side of the foam material 918 to attach the bottom side 914 of the synthetic finger 910 to the top side of the foam material 918. The foam material 918 is used to control the pressure applied to the fingerprint sensor during the testing process.

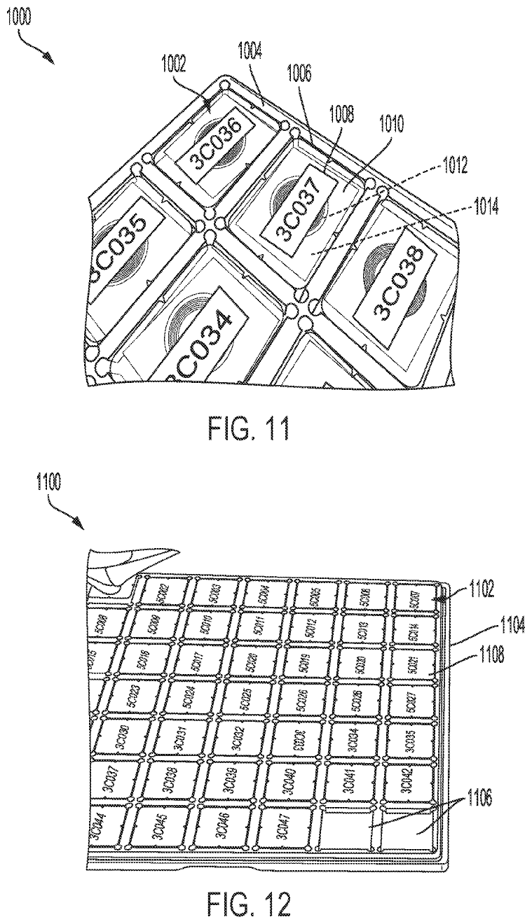

FIG. 11 illustrates a dispensing tray 1000 comprising a plurality of synthetic finger assemblies 1002 manufactured using the process shown in FIG. 10A-10D or 10E, according to at least one aspect of the present disclosure. The dispensing tray 1000 comprises a frame 1004 defining a plurality of cells 1006 arranged in an array. Each cell 1006 is configured to receive and accommodate a synthetic finger assembly 1002. As shown in the aspect illustrated in FIG. 11, each synthetic finger assembly 1002 comprises an identification label 1008, disposed over a substrate 1010, as described in connection with FIG. 10A-10D or 10E. One side of an NFC circuit 1012 is attached to the substrate 1010 and a synthetic finger 1014 is attached to an opposite side of the NFC circuit 1012. In the aspect illustrated in FIG. 11, the synthetic finger 1014 is positioned in a cell 1006 such that the synthetic fingerprint is facing the bottom of a cell 1006. In other words, the opposite side of the synthetic finger 1014 attached to the NFC circuit 1012 is positioned such that it faces the bottom of the cell 1006. In one aspect, the layout configuration of the dispensing tray 1000 is suitable for use in either manual or automated fingerprint/biometric sensor testing process. In an automated testing process, for example, an end effector of a robotic arm picks a synthetic finger assembly 1002 from a cell 1006 of the dispensing tray 1000 and then places the synthetic fingerprint portion of the synthetic finger assembly 1002 on a fingerprint/biometric sensor under test.

FIG. 12 illustrates a dispensing tray 1100 comprising a plurality of synthetic fingerprint assemblies 1102 manufactured using the process shown in FIG. 10A-10D or 10E, according to at least one aspect of the present disclosure. The dispensing tray 1100 comprises a frame 1104 defining a plurality of cells 1106 arranged in an array. Each cell 1106 is configured to receive and accommodate a synthetic finger assembly 1102. As shown in the aspect illustrated in FIG. 12, each synthetic finger assembly 1102 comprises an identification label 1108, disposed over a substrate 1010, as described in connection with FIG. 10A-10D or 10E. One side of an NFC circuit is attached to a substrate and a synthetic finger is attached to an opposite side of the NFC circuit. In the aspect illustrated in FIG. 12, the synthetic fingerprint is located on a bottom side of the synthetic finger assembly 1102 facing the bottom of the cell 1106, which is opposite the side of the synthetic finger attached to the NFC circuit. In one aspect, the layout configuration of the dispensing tray 1100 is suitable for use in either manual or automated fingerprint/biometric sensor testing process. In an automated testing process, for example, an end effector of a robotic arm picks a synthetic finger assembly 1102 from a cell 1106 of the dispensing tray 1100 and places the synthetic fingerprint portion of the synthetic finger assembly 1102 on a fingerprint/biometric sensor under test.

With reference now back to FIG. 1, the process 100 includes an automated testing process 114 for testing a fingerprint sensor using the synthetic finger manufactured according to steps 102-112 of the process 100. Using the synthetic finger manufactured according to steps 102-112 of the process 100. With reference now to FIG. 1 together with FIGS. 11 and 12, a layout of each created synthetic finger assembly 1001, 1102 disposed in dispensing trays 1000, 1100 is configured and optimized to automate the presentation of the synthetic finger assembly 1002, 1102 to a robot. Using a proxy software to the collection software, data from all the synthetic fingerprints can be automatically collected using the NFC circuits 1012 on the synthetic finger assembly 1002, 1102. Data is collected according to the definition for enrollment 116 (enrollment update) defined by the sensor manufacturer (given in the evaluation results definition) and the verification positions 118. The synthetic fingerprint is recognized using a contactless reader. The dataset is automatically labelled using this information.

Still with reference to FIG. 1, the process 100 can include the creation 120 of blind data 122 to prevent cheating. The blind data 122 is provided to an algorithm under evaluation 125. The process of blinding the data includes shuffling and/or renaming the verification data in a way that matching of a data with an enrollment data is written in a separate file and cannot be deduced from the name/structure of the verification file. This step is optional but ensures that cheating the evaluation cannot be easily accomplished, although may still be possible. The result of the shuffling is the blinded data 122 on one side and matching information 128 on the other side.

The algorithm 124 under evaluation is run using the blinded data 122 as a universal attacker (evaluation of the FAR or FRR). The evaluation returns output matching results 126 in a predefined format that allows for automatic evaluation. The matching information 128 and the matching result 126 output by the algorithm 124 are recombined to evaluate 130 the real FAR/FRR. The evaluation process according to various aspects of the present disclosure provides several advantages. For example, the present evaluation process increases the comparability between test laboratory using the same test material and pattern at all labs; increases the repeatability by defining fixed test positions/pressure and test conditions; in case of computer generated fingerprints database, removes privacy concerns; reduces cost and testing time; removes error due to human presentation and labeling (better precision in presentation position); allows testing in pandemic situations; using specific generation design, the generated fingerprint can reflect some trait related to age or ethnicity; and/or using variation in conductivity, foam (pressure level), and environment conditions (humidity and temperature) provides additional advantages to the evaluation process.

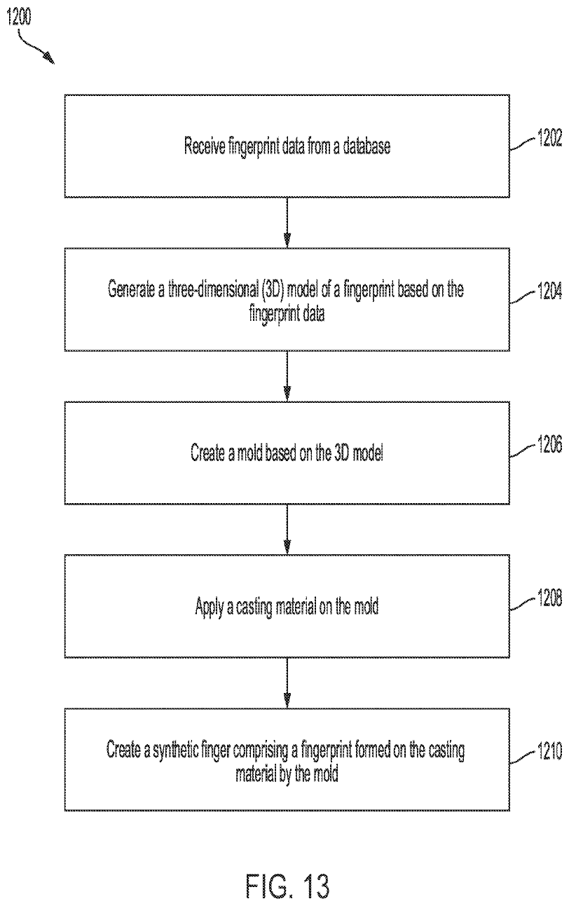

Turning now to FIG. 13, there is illustrated a method 1200 of generating a synthetic finger as described in connection with FIGS. 1-12, according to at least one aspect of the present disclosure. The method 1200 comprises receiving 1202 fingerprint data from a database and generating 1204 a three-dimensional (3D) model of a fingerprint based on the fingerprint data. The method 1200 further comprises creating 1206 a mold based on the 3D model and applying 1208 a casting material is applied on the mold. The method 1200 further comprises creating 1210 a synthetic finger. The synthetic finger comprises a fingerprint formed on the casting material by the mold.

In various aspects, the method 1200 comprises placing the mold in a vacuum chamber, applying a vacuum to the vacuum chamber, and releasing the vacuum before the casting material solidifies. A pressure (vacuum) level of the vacuum chamber is selected in a range of 0.2 bar to 0.8 bar. In another aspect, the method 1200 further comprises removing the synthetic finger from the mold after releasing the vacuum.

In various aspects, the method 1200 comprises applying a foam material to the synthetic finger. In various aspects the foam material has a predetermined thickness or rigidity, or combination thereof, to simulate different pressure levels applied to a fingerprint sensor. In another aspect, the method comprises applying an NFC circuit to the foam material. The NFC circuit can be an RFID tag.

In various aspects, the method 1200 comprises creating the mold by employing an additive process. In another aspect, the additive process can be a high precision 3D printing process. High precision is defined by printed features within a resolution of 1 to 5 micrometers.

In various aspects, the method 1200 comprises creating the mold by employing a subtractive process. In another aspect, the subtractive process can be at least one of a high precision laser engraving or laser etching process. High precision is defined by engraved features within a resolution of 1 to 5 micrometers.

In various aspects, the method 1200 comprises combining at least one of a jellifying product, a polymer product, or an additive, or any combination thereof in a predetermined ratio to reflect properties of human skin. The combination includes a mix of gelatin, glycerin, water, salt and acrylic paint with the following proportions (relative to the total mass in grams): Glycerin [37-52%], Gelatin [8-16%], Salt (e.g., Sodium chloride and/or Magnesium chloride) [0-3%], Acrylic Paint [0-1%], Completed with Distilled Water to 100% of the mass ([30-55%]). In another aspect, the casting material can be liquid or a film. In one aspect, the jellifying material comprises at least one of gelatin, pectin casein, or agar, or any combination thereof. In one aspect, the polymer material comprises at least one of a natural glue or an artificial glue, or any combination thereof. In another aspect, the properties of human skin comprise at least one of optical, mechanical, conductivity, or thermal, or any combination thereof.

In various aspects, the method 1200 comprises applying a near field communication (NFC) circuit to a substrate. In another aspect, the NFC circuit, or RFID tag, is applied to the synthetic finger. In another aspect, the NFC circuit, or RFID tag, is applied to the foam material. In one aspect, the NFC circuit can be an RFID tag.

In various aspects, the method 1200 comprises modifying a fingerprint generated based on real fingerprint data to create the fingerprint used to create the mold. In another aspect, the method 1200 comprises generating a near human fingerprint to create the fingerprint used to create the mold. In another aspect, the database is a high resolution database, wherein high resolution is at least 500 pixels per inch. In another method, the fingerprint is one of an artificial fingerprint, wherein an artificial fingerprint is one of a modified human fingerprint or a wholly created fingerprint independent of a human fingerprint. In another aspect, the mold is a negative form of the fingerprint.

FIG. 14 is a block diagram of a computer apparatus 3000 with data processing subsystems or components, according to at least one aspect of the present disclosure. The computer apparatus 3000 may be configured to implement the computer functions in the process 100 described in connection with FIG. 1. The subsystems shown in FIG. 14 are interconnected via a system bus 3010. Additional subsystems such as a printer 3018, keyboard 3026, fixed disk 3028 (or other memory comprising computer readable media), monitor 3022, which is coupled to a display adapter 3020, and others are shown. Peripherals and input/output (I/O) devices, which couple to an I/O controller 3012 (which can be a processor or other suitable controller), can be connected to the computer system by any number of means known in the art, such as a serial port 3024. For example, the serial port 3024 or external interface 3030 can be used to connect the computer apparatus to a wide area network such as the Internet, a mouse input device, or a scanner. The interconnection via system bus allows the central processor 3016 to communicate with each subsystem and to control the execution of instructions from system memory 3014 or the fixed disk 3028, as well as the exchange of information between subsystems. The system memory 3014 and/or the fixed disk 3028 may embody a computer readable medium.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media, and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one aspect of a bus. Transmission media can also take the form of acoustic or light waves, such as those generated during radio frequency (RF) and infrared (IR) data communications. Common forms of computer-readable media include, for example, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASH EPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object-oriented programming language such as Java, Smalltalk, C++, or the like and conventional procedural programming languages, such as the “C” programming language, Go, Python, or other programming languages, including assembly languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Examples of the method according to various aspects of the present disclosure are provided below in the following numbered clauses. An aspect of the method may include any one or more than one, and any combination of, the numbered clauses described below.
Clause 1. A method of generating a synthetic finger, the method comprising: receiving fingerprint data from a database; generating a three-dimensional (3D) model of a fingerprint based on the fingerprint data; creating a mold based on the 3D model; applying a casting material on the mold; and creating a synthetic finger comprising a fingerprint formed on the casting material by the mold.
Clause 2. The method of clause 1, comprising: placing the mold in a vacuum chamber; applying a vacuum to the vacuum chamber; and releasing the vacuum before the casting material solidifies.
Clause 3. The method of clause 2, wherein a pressure level of the vacuum chamber is selected in a range of 0.2 bar to 0.8 bar.
Clause 4. The method of any one of clauses 1-3, comprising removing the synthetic finger from the mold after releasing the vacuum.
Clause 5. The method of any one of clauses 1-4, comprising applying a foam material to the synthetic finger.
Clause 6. The method of clause 5, wherein the foam material has a predetermined thickness or rigidity, or combination thereof, to simulate different pressure levels applied to a fingerprint sensor.
Clause 7. The method of any one of clauses 5-6, comprising applying a near field communication (NFC) circuit to the foam material.
Clause 8. The method of clause 7, wherein the NFC circuit is a radio frequency identification (RFID) tag.
Clause 9. The method of any one of clauses 1-8, wherein creating the mold employs an additive process.
Clause 10. The method of clause 9, wherein the additive process is a high precision 3D printing process, where high precision is defined by printed features within a resolution of 1 to 5 micrometers.
Clause 11. The method of any one of clauses 1-10, wherein creating the mold employs a subtractive process.
Clause 12. The method of clause 11, wherein the subtractive process is at least one of a high precision laser engraving or laser etching process, where high precision is defined by engraved features within a resolution of 1 to 5 micrometers.
Clause 13. The method of any one of clauses 1-12, comprising combining at least one of a jellifying product, a polymer product, or an additive, or any combination thereof in a predetermined ratio to reflect properties of human skin.
Clause 14. The method of clause 13, wherein the combination includes a mixture of gelatin, glycerin, water, salt, and acrylic paint with the following proportions relative to the total mass in grams: Glycerin [37-52%], Gelatin [8-16%], Salt [0-3%], Acrylic Paint [0-1%], completed with Distilled Water to 100% of the mass ([30-55%]).
Clause 15. The method of clause 14, wherein the Salt includes at least one of Sodium Chloride or Magnesium Chloride.
Clause 16. The method of any one of clauses 13-15, wherein the casting material can be liquid or a film.
Clause 17. The method of any one of clauses 13-16, wherein the jellifying material comprises at least one of gelatin, pectin casein, or agar, or any combination thereof.
Clause 18. The method of any one of clauses 13-17, wherein the polymer material comprises at least one of a natural glue or an artificial glue, or any combination thereof.
Clause 19. The method of any one of clause 13-18, wherein the properties of human skin comprises at least one of optical, mechanical, conductivity, or thermal, or any combination thereof.
Clause 20. The method of any one of clauses 1-19, comprising applying a near field communication (NFC) circuit to a substrate.
Clause 21. The method of clause 20, wherein the NFC circuit is a radio frequency identification (RFID) tag.
Clause 22. The method of any one of clauses 1-21, comprising applying a near field communication (NFC) circuit to the synthetic finger.
Clause 23. The method of clause 22, wherein the NFC circuit is a radio frequency identification (RFID) tag.
Clause 24. The method of any one of clauses 1-23, wherein creating a 3D model of the fingerprint comprises creating a displacement map of ridges with a maximum vertical displacement selected in a range of 33 and 80 micrometers.
Clause 25. The method of any one of clauses 1-24, comprising modifying a fingerprint generated based on real fingerprint data to create the fingerprint used to create the mold.
Clause 26. The method of any one of clauses 1-25, comprising generating a near human fingerprint to create the fingerprint used to create the mold.
Clause 27. The method of any one of clauses 1-26, wherein the database is a high resolution database, wherein high resolution is at least 500 pixels per inch.
Clause 28. The method of any one of clauses 1-27, wherein the fingerprint is one of an artificial fingerprint, wherein an artificial fingerprint is one of a modified human fingerprint or a wholly created fingerprint independent of a human fingerprint.
Clause 29. The method of any one of clauses 1-28, wherein the mold is a negative form of the fingerprint.
Clause 30. A synthetic finger assembly, the synthetic finger assembly comprising: a substrate; a near field communication (NFC) circuit disposed on one side of the substrate; and a synthetic finger disposed on the NFC circuit.
Clause 31. The synthetic finger assembly of clause 30, comprising a foam material with a predetermined thickness disposed between the NFC circuit and the synthetic finger.
Clause 32. The synthetic finger assembly of any one of clauses 30-31, wherein an adhesive is disposed between the substrate and the NFC circuit, between the NFC circuit and the foam material, and between the foam material and the synthetic fingerprint.
Clause 33. The synthetic finger assembly of any one of clauses 30-32, wherein the synthetic finger is formed from a mixture of a jellifying product, a polymer product, or an additive, or any combination thereof in a predetermined ratio to reflect properties of human skin.
Clause 34. The synthetic finger assembly of clause 33, wherein the combination includes a mixture of gelatin, glycerin, water, salt and acrylic paint with the following proportions relative to the total mass in grams: Glycerin [37-52%], Gelatin [8-16%], Salt [0-3%], Acrylic Paint [0-1%], completed with Distilled Water to 100% of the mass ([30-55%]).
Clause 35. The synthetic finger assembly of clause 34, wherein the Salt includes at least one of Sodium Chloride or Magnesium Chloride.
Clause 36. The synthetic finger assembly of any one of clauses 33-35, wherein the jellifying product is at least one of gelatin, pectin casein, or agar, or any combination thereof.
Clause 37. The synthetic finger assembly of any one of clauses 33-36, wherein the polymer product is at least one of natural glues or artificial glues, or any combination thereof.
Clause 38. The synthetic finger assembly of any one of clauses 33-37, wherein the properties of human skin is at least one of optical, mechanical, conductivity, or thermal, or any combination thereof.
Clause 39. The synthetic finger assembly of any one of clauses 31-38, wherein the foam material has a predetermined thickness or rigidity, or combination thereof, to simulate different pressure levels applied to a fingerprint sensor.
Clause 40. The synthetic finger assembly of any one of clauses 30-39, wherein the synthetic finger comprises a three-dimensional fingerprint.
Clause 41. The synthetic finger assembly of clause 40, wherein the three-dimensional fingerprint is an artificial fingerprint, wherein the artificial fingerprint is one of a modified human fingerprint or a wholly created fingerprint independent of a human fingerprint.
Clause 42. The synthetic finger assembly of any one of clauses 30-41, wherein an adhesive is disposed between the substrate and the NFC circuit and between the NFC circuit and the synthetic fingerprint.
Clause 43. The synthetic finger of any one of clauses 30-42, wherein the NFC circuit is a radio frequency identification (RFID) tag.
Clause 44. A method of generating a synthetic finger, the method comprising:
receiving fingerprint data from a database; generating a plurality of three-dimensional (3D) models of a plurality of fingerprints based on the fingerprint data; creating a mold based on the 3D model for each of the plurality of fingerprints; creating an array of molds by combining each mold for each of the plurality of fingerprints; applying a casting material to the array of molds forming a sheet of casting material; and segmenting the sheet into individual synthetic fingers, wherein the synthetic fingers comprise a fingerprint formed on the casting material by the mold.

The foregoing detailed description has set forth various forms of the systems and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution.

Instructions used to program logic to perform various disclosed aspects can be stored within a memory in the system, such as dynamic random access memory (DRAM), cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, compact disc, read-only memory (CD-ROMs), and magneto-optical disks, read-only memory (ROMs), random access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

Any of the software components or functions described in this application, may be implemented as software code to be executed by a processor using any suitable computer language such as, for example, Python, Java, C++ or Perl using, for example, conventional or object-oriented techniques. The software code may be stored as a series of instructions, or commands on a computer readable medium, such as RAM, ROM, a magnetic medium such as a hard-drive or a floppy disk, or an optical medium such as a CD-ROM. Any such computer readable medium may reside on or within a single computational apparatus and may be present on or within different computational apparatuses within a system or network.

As used in any aspect herein, the term “logic” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

As used in any aspect herein, the terms “component,” “system,” “module” and the like can refer to a computer-related entity, either hardware, a combination of hardware and software, software, or software in execution.

As used in any aspect herein, an “algorithm” refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

A network may include a packet switched network. The communication devices may be capable of communicating with each other using a selected packet switched network communications protocol. One example communications protocol may include an Ethernet communications protocol which may be capable of permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in December 2008 and/or later versions of this standard. Alternatively or additionally, the communication devices may be capable of communicating with each other using an X.25 communications protocol. The X.25 communications protocol may comply or be compatible with a standard promulgated by the International Telecommunication Union-Telecommunication Standardization Sector (ITU-T). Alternatively or additionally, the communication devices may be capable of communicating with each other using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, the transceivers may be capable of communicating with each other using an Asynchronous Transfer Mode (ATM) communications protocol. The ATM communications protocol may comply or be compatible with an ATM standard published by the ATM Forum titled “ATM-MPLS Network Interworking 2.0” published August 2001, and/or later versions of this standard. Of course, different and/or after-developed connection-oriented network communication protocols are equally contemplated herein.

Unless specifically stated otherwise as apparent from the foregoing disclosure, it is appreciated that, throughout the present disclosure, discussions using terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material. None is admitted to be prior art.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

What is claimed is:

1. A method of generating a synthetic finger, the method comprising:
receiving fingerprint data from a database;
generating a three-dimensional (3D) model of a fingerprint based on the fingerprint data;
creating a mold based on the 3D model;
applying a casting material on the mold; and
creating a synthetic finger comprising a fingerprint formed on the casting material by the mold.

2. The method of claim 1, comprising:
placing the mold in a vacuum chamber;
applying a vacuum to the vacuum chamber; and
releasing the vacuum before the casting material solidifies.

3. The method of claim 2, wherein a pressure level of the vacuum chamber is selected in a range of 0.2 bar to 0.8 bar.

4. The method of claim 1, comprising applying a foam material to the synthetic finger, wherein the foam material has a predetermined thickness or rigidity, or combination thereof, to simulate different pressure levels applied to a fingerprint sensor.

5. The method of claim 4, comprising applying a near field communication (NFC) circuit to the foam material.

6. The method of claim 1, wherein creating the mold employs a 3D printing additive process defined by printed features having a resolution of 1 to 5 micrometers.

7. The method of claim 1, wherein creating the mold employs a subtractive process including at least one of a high precision laser engraving or laser etching process defined by engraved features having a resolution of 1 to 5 micrometers.

8. The method of claim 1, comprising a combination of at least one of a jellifying product, a polymer product, or an additive, or any combination thereof in a predetermined ratio to reflect properties of human skin, wherein the combination includes a mixture of gelatin, glycerin, water, salt, and acrylic paint with the following proportions relative to a total mass in grams: Glycerin [37-52%], Gelatin [8-16%], Salt [0-3%], Acrylic Paint [0-1%], completed with Distilled Water to 100% of the total mass [30-55%].

9. The method of claim 8, wherein the jellifying product comprises at least one of gelatin, pectin casein, or agar, or any combination thereof.

10. The method of claim 1, comprising applying a near field communication (NFC) circuit to a substrate or the synthetic finger.

11. The method of claim 1, wherein creating a 3D model of the fingerprint comprises creating a displacement map of ridges with a maximum vertical displacement selected in a range of 33 and 80 micrometers.

12. The method of claim 1, comprising modifying a fingerprint generated based on real fingerprint data to create the fingerprint used to create the mold.

13. The method of claim 1, wherein the database has a resolution of at least 500 pixels per inch.

14. The method of claim 1, wherein the fingerprint is one of an artificial fingerprint, wherein an artificial fingerprint is one of a modified human fingerprint, or a wholly created fingerprint independent of a human fingerprint.

15. A synthetic finger assembly, the synthetic finger assembly comprising:
a substrate;
a near field communication (NFC) circuit disposed on one side of the substrate; a synthetic finger disposed on the NFC circuit; and
a foam material with a predetermined thickness disposed between the NFC circuit and the synthetic finger, wherein an adhesive is disposed between the substrate and the NFC circuit, between the NFC circuit and the foam material, and between the foam material and the synthetic finger.

16. The synthetic finger assembly of claim 15, wherein the synthetic finger comprises a combination of at least one of a jellifying product, a polymer product, or an additive, or any combination thereof in a predetermined ratio to reflect properties of human skin, wherein the combination includes a mixture of gelatin, glycerin, water, salt and acrylic paint with the following proportions relative to a total mass in grams: Glycerin [37-52%], Gelatin [8-16%], Salt [0-3%], Acrylic Paint [0-1%], completed with Distilled Water to 100% of the total mass [30-55%].

17. The synthetic finger assembly of claim 16, wherein the jellifying product is at least one of gelatin, pectin casein, or agar, or any combination thereof.

18. The synthetic finger assembly of claim 15, wherein the synthetic finger comprises a three-dimensional artificial fingerprint.

19. The synthetic finger assembly of claim 15, wherein an adhesive is disposed between the substrate and the NFC circuit and between the NFC circuit and the synthetic finger.

20. A method of generating a synthetic finger, the method comprising:
receiving fingerprint data from a database;
generating a plurality of three-dimensional (3D) models of a plurality of fingerprints based on the fingerprint data;
creating a mold based on the 3D model for each of the plurality of fingerprints;
creating an array of molds by combining each mold for each of the plurality of fingerprints;
applying a casting material to the array of molds forming a sheet of casting material; and
segmenting the sheet into individual synthetic fingers, wherein the synthetic fingers comprise a fingerprint formed on the casting material by the mold.
